(19) United States
(12) Patent Application Publication
(10) Pub. No.: US 2014/0049462 A1
(43) Pub. Date: Feb. 20, 2014

(54) USER INTERFACE ELEMENT FOCUS BASED ON USER'S GAZE

(71) Applicants: Arthur Weinberger, Sunnyvale, CA (US); Sergio Marti, Sunnyvale, CA (US); Yegor Gennadiev Jbanov, Mountain View, CA (US); Liya Su, Sunnyvale, CA (US); Mohammadinamul Hasan Sheik, Santa Clara, CA (US); Anusha Iyer, Santa Clara, CA (US)

(72) Inventors: Arthur Weinberger, Sunnyvale, CA (US); Sergio Marti, Sunnyvale, CA (US); Yegor Gennadiev Jbanov, Mountain View, CA (US); Liya Su, Sunnyvale, CA (US); Mohammadinamul Hasan Sheik, Santa Clara, CA (US); Anusha Iyer, Santa Clara, CA (US)

(73) Assignee: Google Inc.

(21) Appl. No.: 13/589,961

(22) Filed: Aug. 20, 2012

(51) Int. Cl. G06F 3/01

(52) U.S. Cl. 345/156

(57) ABSTRACT

A computerized method, system for, and computer-readable medium operable to: determine a set of coordinates corresponding to a user's gaze; determine a user interface (UI) element corresponding to the set of coordinates; return that UI element as being detected and again repeating the determination of the set of coordinates corresponding to the user's gaze; determine if the UI element being returned is the same for a predetermined threshold of time according to a started timer; if the UI element is not the same, reset the started timer and again repeating the determination of the set of coordinates corresponding to the user's gaze; and if the UI element is the same, making the UI element active without requiring any additional action from the user and currently selecting the UI element to receive input.

### BACKGROUND

The present disclosure relates generally to graphic user interface (GUI) displays on any device which may display them.

Users of GUI displays which have many windows open sometimes accidentally start typing or clicking in the wrong window. For instance, a user could be looking at one window or screen element and the computer could not realize that a different screen element currently has a cursor. It may require cumbersome actions such as moving a mouse, clicking or performing keyboard shortcuts to switch active windows. However, these approaches are inefficient and also are approximations or proxies for determining where the user's attention is, or which window the user wants to interact with.

### SUMMARY

In one embodiment, a computer is configured to: determine a set of coordinates corresponding to a user's gaze; determine a user interface (UI) element corresponding to the set of coordinates; return that UI element as being detected and again repeating the determination of the set of coordinates corresponding to the user's gaze; determine if the UI element being returned is the same for a predetermined threshold of time according to a started timer; if the UI element is not the same, reset the started timer and again repeating the determination of the set of coordinates corresponding to the user's gaze; and if the UI element is the same, making the UI element active without requiring any additional action from the user and currently selecting the UI element to receive input.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with an aspect of the present disclosure.

FIG. 2 is an illustration of a display showing example windows and GUIs and also at least one sensor, in accordance with an aspect of the present disclosure.

FIG. 3 is an illustration of possible placement of windows in a display, in accordance with an aspect of the present disclosure.

FIG. 4 is a block diagram of a user interface system, in accordance with an aspect of the present disclosure.

FIG. 5 is an example process for providing window selection based on sensor data such as eye tracking, for example, in accordance with an aspect of the present disclosure.

FIG. 6 is another example process for providing window selection based on sensor data such as eye tracking, for example, in accordance with an aspect of the present disclosure.

### DETAILED DESCRIPTION OF ILLUSTRATIVE IMPLEMENTATIONS

According to aspects of the present disclosure, a sensor such as a camera can track the location on a display screen being looked at by a user or other user data in order to adjust the window selection or making a window active out of a number of different windows. In one embodiment, selecting a window and making it active is known as “focus” or “providing focus” of a given window, and it may be referred to as “focus” for simplicity throughout the remainder of the present disclosure. The focus may be based on the user's attention, e.g., when the user looks at a window long enough, that window is raised to the foreground and given focus (made active). The delay for raising a window may also be configurable and adjustable according to a variety of parameters. Accordingly, being able to select windows and adjust window focus may be possible without having to click on windows, move a mouse to a window, or rely on shortcut keys.

According to one aspect of the present disclosure, the focus detector may be implemented as software embodied on a tangible medium in an application to be used on a computer or on an application used on a mobile device. The computer of mobile device may already have a built-in camera or other motion sensor that may be forward facing or backwards facing and already configured to detect the eye movement or other movement—based action from the user. In one implementation, off-the-shelf eye-tracking software embodied on a tangible medium may be used in combination with a webcam.

According to one aspect of the present disclosure, a processing circuit to track where a user's gaze is focused at on a screen may replace keyboard or mouse input. In one implementation, the sensor or camera may be infrared. In one implementation, if the camera is blocked, or multiple users are detected, a fail-safe mode that still detects or approximates movement is executed. In one implementation, functions that can be carried out by the focus detector include minimizing windows, maximizing windows, selecting objects on a web page, clicking links, playing videos and so on. In one implementation, once a user interface element is selected, sub-user interface elements or smaller components of that user interface element (such as buttons or a text box or icons and the sort) may also be interacted with via the user's gaze. In one implementation, when the user's gaze focuses on an object, the window or the user interface element does not zoom in, nor is the screen size or aspect ratio of the screen or window size adjusted.

According to one aspect of the present disclosure, focus is a term used in computing that indicates the component of the GUI which is currently selected to receive input. The focus can usually be changed by clicking on a component that may receive focus with the mouse or keyboard, for example. Many desktops also allow the focus to be changed with the keyboard, via shortcut keys for example. By convention, the “alt+tab” key may be used to move the focus to the next focusable component and/or, in some implementations, “shift+tab” to the previous focusable component. When graphical interfaces were also first introduced, many computers did not have mice or other such input devices; therefore the shortcut keys were necessary. The shortcut key feature also makes it easier for people who have a hard time using a mouse to navigate the user interface, such as, for example, people with hand disabilities or carpal tunnel syndrome. In one implementation, arrow keys, letter keys or other motion keys may be used to move focus.

A “focus follows click” or “click to focus” policy is where a user must click the mouse inside of the window for that window to gain focus. This also typically results in the window being raised above or laid over one or more or all other windows on the screen of a display. If a “click focus” model such as this is being used, the current application window that is “active” continues to retain focus and collect input, even if the mouse pointer may be over another application window. Another policy on UNIX systems, for example, is the “focus follows mouse” policy (or FFM) where the focus automatically follows the current placement of the pointer controlled by the mouse. The focused window is not necessarily raised, and parts of it may remain below other windows. Window managers with this policy usually offer an “auto-raise” functionality which raises the window when it is focused, typically after a configurable short delay that may occur after a predetermined time period. One consequence of FFM policy is that no window has focus when the pointer is moved over the background with no window underneath. Individual components on a screen may also have a cursor position (represented by, for example, an x and y coordinate). For instance, in a text editing package, the text editing window must have the focus so that text can be entered. When text is entered into the component, it will appear at the position of the text-cursor, which may also normally be moveable using the mouse cursor. X window managers may be another type of window manager which have historically provided vendor-controlled, fixed sets of ways to control how windows and panes display on a screen, and how the user may interact with them. Window management for the X window system may also be kept separate from the software providing the graphical display. In one implementation, the X window system may be modified for the focus detector of the present disclosure, or enhanced. In one implementation, the X window system may be used with the focus detector of the present disclosure. In one implementation, a different window system than the X window system may be used with the focus detector of the present disclosure. In one implementation, the window selected by the user's gaze becomes active and allows for instant user input without requiring any additional action from the user, e.g., the user does not have to click on the selected window or perform any additional actions to make the selected window active. In one implementation, a text input box within the actively selected window can be made ready for input. In one implementation, once selected, the UI element also becomes available for input, such as, movement, typing into, resizing, minimizing, closing, and so on

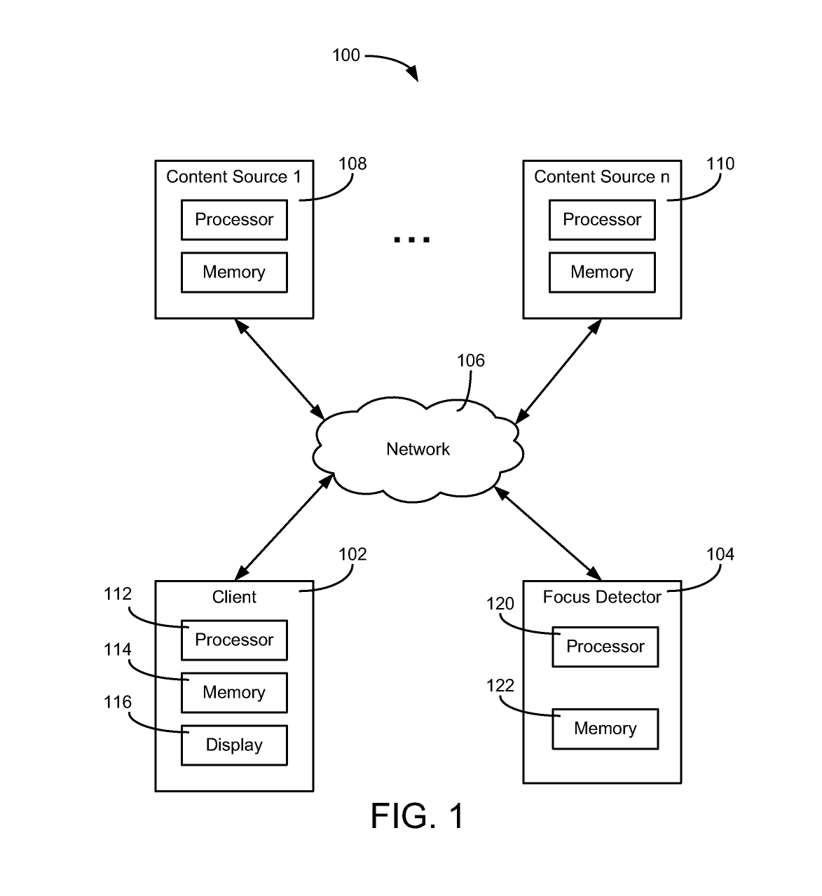

FIG. 1 is a block diagram of a computer system in accordance with an aspect of the present disclosure. Referring to FIG. 1, a block diagram of a computer system 100 in accordance with a described implementation is shown. System 100 includes a client 102 which communicates with other computing devices via a network 106. Client 102 may execute a web browser or other application (e.g., a video game, a messaging program, etc.) to retrieve content from other devices over network 106. For example, client 102 may communicate with any number of content sources 108, 110 (e.g., a first content source through nth content source), which provide electronic content to client 102, such as web page data and/or other content (e.g., text documents, PDF files, and other forms of electronic documents). In some implementations, computer system 100 may also include a focus detector 104 configured to analyze data provided by a content source 108, 110, such as motion data from a camera or another motion sensor, and use that data to instruct the client 102 to perform an action, such as selecting or focusing on a window out of a number of windows. Focus detector 104 may also analyze data from a content source 108, 110 and provide it back to a content source 108, 110, such as for example if the content source 108, 110 needs to perform some type of feedback analysis on the motion of the user, or needs to ascertain information such as the presence of other users or if objects are blocking a camera or motion sensor, or when to utilize a back-up plan in case none of the primary actions may be available.

Network 106 may be any form of computer network that relays information between client 102, content sources 108, 110, and focus detector 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CAT5 cable, etc.) to other computing devices in network 106.

Client 102 may be any number of different types of electronic devices configured to communicate via network 106 (e.g., a laptop computer, a desktop computer, a tablet computer, a smartphone, a digital video recorder, a set-top box for a television, a video game console, combinations thereof, etc.). Client 102 is shown to include a processor 112 and a memory 114, i.e., a processing circuit. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python and Visual Basic.

Client 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, a webcam, a camera, etc.). The one or more user interface devices may be internal to the housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which displays web pages and other forms of content received from content sources 108, 110 and/or focus detector 104.

Content sources 108, 110 may be one or more electronic devices connected to network 106 that provide content to client 102. For example, content sources 108, 110 may be computer servers (e.g., FTP servers, file sharing servers, web servers, etc.) or combinations of servers (e.g., data centers, cloud computing platforms, etc.). Content may include, but is not limited to, motion sensor data, visual data on movement, other sensor data, web page data, a text file, a spreadsheet, an image file, social media data (posts, messages, status updates), media files, video files, and other forms of electronic documents. Similar to client 102, content sources 108, 110 may include processing circuits comprising processors 124, 118 and memories 126, 128, respectively, that store program instructions executable by processors 124, 118. For example, the processing circuit of content source 108 may include instructions such as web server software, FTP serving software, and other types of software that cause content source 108 to provide content via network 106.

Focus detector 104 may be one or more electronic devices connected to network 106 and configured to analyze and organize sensor data associated with client 102 and/or other clients and/or content sources 108, 110. Focus detector 104 may be a computer server (e.g., FTP servers, file sharing servers, web servers, etc.) or a combination of servers (e.g., a data center, a cloud computing platform, etc.). Focus detector 104 may also include a processing circuit including a processor 120 and a memory 122 that stores program instructions executable by processor 120. In cases in which focus detector 104 is a combination of computing devices, processor 120 may represent the collective processors of the devices and memory 122 may represent the collective memories of the devices. In other implementations, the functionality of focus detector 104 may be integrated into content sources 108, 110 or other devices connected to network 106. Focus detector 104 may be on a server side or client side of a network, and may be part of a personal computer, smart TV, smart phone, or other client-side computing device. Focus detector 104 may also include off-the-shelf eye detection software configured to detect, track and analyze eye movement based on an attached simple camera such as a webcam.

Focus detector 104 may store user identifiers to represent users of computing system 100. A user identifier may be associated with one or more client identifiers. For example, a user identifier may be associated with the network address of client 102 or a cookie that has been set on client 102, or a network address or cookie of one of the content sources 108, 110. A user identifier may be associated with any number of different client identifiers. For example, a user identifier may be associated with a device identifier for client 102 and another client device connected to network 106 or a content source 108, 110. In other implementations, a device identifier for client 102 may itself be used in computing system 100 as a user identifier.

A user of client 102 may opt in or out of allowing focus detector 104 to identify and store data relating to client 102 and the user. For example, the user may opt in to receiving content or data processed or analyzed by focus detector 104 that may be more relevant to him or her or their actions. In one implementation, a client identifier and/or device identifier for client 102 may be randomized and contain no personally-identifiable information about the user of client 102. Thus, the user of client 102 may have control over how information is collected about the user and used by focus detector 104, in various implementations.

In cases in which the user of client 102 opts in to receiving more relevant content, focus detector 104 may determine specific types of physical actions, eye actions, vision settings, medical conditions or other preferences that may be unique to a certain user so as to better tailor the window selection process for that user. In some implementations, an analysis of common settings that work for a wide variety of users having particular conditions or preferences for focus detector 104 may be achieved by analyzing activity associated with the set of user identifiers. In general, any data indicative of a preference, medical condition, or setting associated with a user identifier may be used as a signal by focus detector 104. For example, a signal associated with a user identifier may be indicative of a particular vision setting, a certain medical condition, an eye condition, a refresh rate of blinking on an eye, a speed at which an eye or other body part moves, whether the user is wearing glasses or contacts, how frequently the user blinks naturally and/or due to other medical conditions, etc. Signals may be stored by focus detector 104 in memory 122 and retrieved by processor 120 to generate instructions to the client for adjusting the focus and selection of windows. In some implementations, signals may be received by focus detector 104 from content sources 108, 110. For example, content source 108 may provide data to focus detector 104 regarding shutter settings on a camera, frequency settings on a camera, resolution, sensor sample rate, sensor data, sensor speed, number of samples to take, accuracy of measurement and so on. In further implementations, data regarding online actions associated with client 102 may be provided by client 102 to focus detector 104 for analysis purposes. In one example, a focus detection algorithm offered by OpenEyes may be used. See, e.g., Li, D., and Parkhurst, D. J., “Open-source software for real-time visible-spectrum eye tracking” Proceedings of the COGAIN Conference, pgs. 18-20 (2006).

A set of one or more user identifiers may be evaluated by focus detector 104 to determine how strongly a particular signal relates to the user identifiers in the set. The set may be selected randomly or based on one or more characteristics of the set. For example, the set may be selected for evaluation based on age ranges of a certain set (e.g., user identifiers associated with a particular range of ages which may be more likely to have certain eye conditions), based on one or more signals associated with the identifiers (e.g., user identifiers associated with particular eye conditions, particular medical conditions, particular eye or action settings or preferences), any other characteristic, or a combination thereof. In some implementations, focus detector 104 may determine the strength of association between a signal and the set using a statistical measure of association. For example, focus detector 104 may determine the strength of association between the set and a particular signal using a point-wise mutual information (PMI) score, a Hamming distance analysis, a term-frequency inverse-document-frequency (TF-IDF) score, a mutual information score, a Kullback-Leibler divergence score, any other statistical measure of association, or combinations thereof.

In some implementations, focus detector 104 may be able to have pre-set settings and preferences based on reoccurring conditions such as astigmatism, near-sightedness, or other eye conditions that would require specific parameters to best detect eye motion and translate that eye motion into an instruction for window selection. In some implementations, the focus detector 104 may also have preferences based on reoccurring preferences or settings related to any user-based motion that can be detected or analyzed by a sensor.

Relevant data may be provided to client 102 by content sources 108, 110 or focus detector 104. For example, focus detector 104 may select relevant content from content sources 108, 110 such as particular motion sensor data in order to provide a filtered analysis or other type of analysis to the client 102 for window selection. In another example, focus detector 104 may provide the selected content to client 102, via code, instructions, files or other forms of data. In some implementations, focus detector 104 may select content stored in memory 114 of client 102. For example, previously provided content may be cached in memory 114, content may be preloaded into memory 114 (e.g., as part of the installation of an application), or may exist as part of the operating system of client 102. In such a case, focus detector 104 may provide an indication of the selection to client 102. In response, client 102 may retrieve the selected content from memory 114 and display it on display 116.

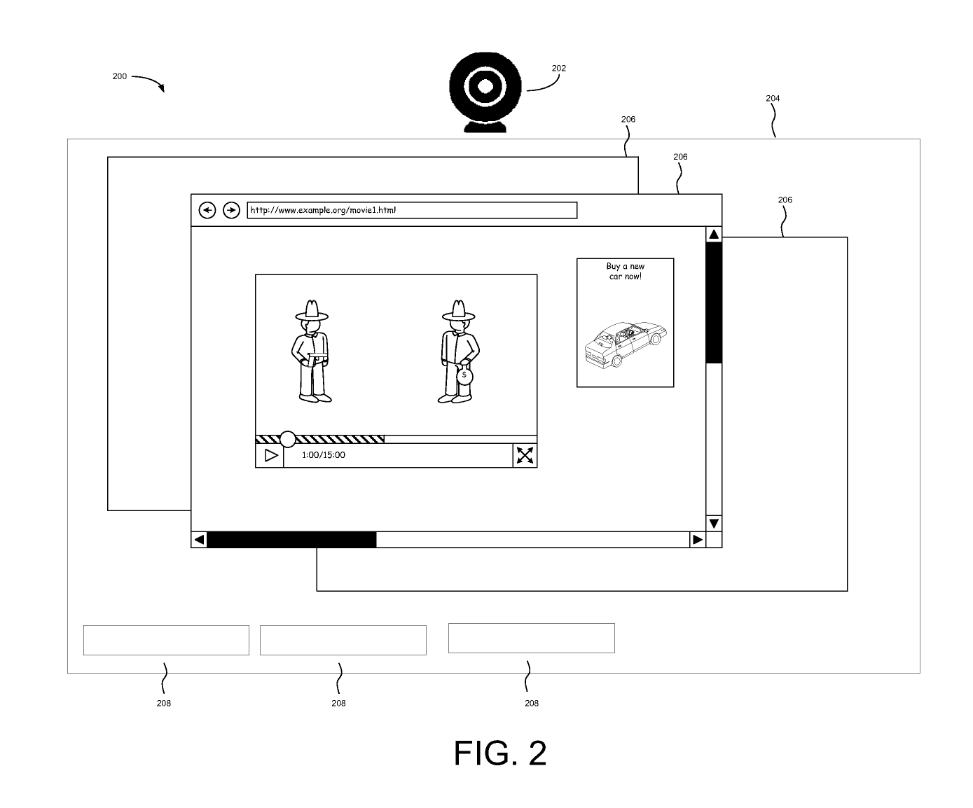

FIG. 2 is an illustration of a display showing example windows and GUIs and also at least one sensor, in accordance with an aspect of the present disclosure. Referring now to FIG. 2, an example display setup 200 is shown which includes sensor 202, display 204, at least one window 206, and at least one minimized window 208. Sensor 202 may be any type of motion sensor, video camera, web camera, device that records or detects motion or action from the user, or sensor that detects motion or action from the user. In one implementation, the sensor 202 may be a web camera or a simple camera device that detects the eye motion of a user. In one implementation, the sensor 202 may be a built-in camera on a mobile device that detects the eye motion of a user. In one implementation, the sensor 202 may be a motion sensor that detects the movement of the user's face, arms, eyebrows, nose, mouth, or other body parts of the user in order to detect motion or action from the user. In one implementation, off-the-shelf eye detection software may be used in tandem with the sensor 202, particularly if the sensor 202 is a web camera or a similar camera.

Display 204 is in electronic communication with one or more processors that cause visual indicia to be provided on display 204. Display 204 may be located inside or outside of the housing of the one or more processors. For example, display 204 may be external to a desktop computer (e.g., display 204 may be a monitor), may be a television set, or any other stand-alone form of electronic display. In another example, display 204 may be internal to a laptop computer, mobile device, or other computing device with an integrated display.

Within the screen of the display 204, there may be at least one or more than one windows 206. As shown in the example window 206, a web browser application may be displayed. Other types of content, such as an open application, status window, GUI, widget, or other program content may be displayed in other windows 206, that may not be currently the “active” window 206 in which the user is working on, typing in, or interacting with. In one implementation, a user may only interact with one window 206 at a time, that is, a user may only click, interact, type in one window 206 while the other windows 206 are in the background and even though can be seen, cannot be interacted with at that present moment. In that case, however, two windows 206 can be placed side-by-side to work on, but only one window 206 from the two can be actively interacted with at a time. In one implementation, there may be no limit to the number of open windows 206 that can be open, however this may be limited by the processor of the device running the display 204. In one implementation, the windows 206 can be moved to be overlaid or overlapped over one another. In one implementation, the windows 206 can be made transparent so as to see the content of other windows 206 underneath it, without having to move that window out of the way. In one implementation, the user may interact with (e.g., click, select, “mouse over,” expand, or other interactions) objects within the windows 206 using his or her gaze, the objects being for example, buttons, icons, text boxes, or cursors for text that can be moved. In one implementation, when the user's gaze focuses on an user interface element, the user interface element or the window having the user interface element does not zoom in, nor is the screen size or aspect ratio of the screen or window size adjusted.

Also within the screen of the display 204, there may be at least one or more than one minimized windows 208. These are windows 206 that have been minimized into a form that take the shape of tabs or miniature buttons that offer a condensed version of a window 206 without having to actually see the window 206. Also, all open windows 206 may have a corresponding minimized window 208, therefore the current “active” window 206 may be toggled by selecting the corresponding minimized window 208 tab. As a result, the currently selected window 206 might also reflect a currently selected minimized window 208 tab, such as, for example, the tab being sunken in or highlighted with a different color or related differentiation. In one implementation, if a preselected number of windows 208 is open, then all the minimized windows 208 combine into one minimized window 208 tab for efficiency and space-saving reasons. By clicking on that one minimized window tab 208, the user may select which window out of all the open windows 206 to currently select as active, as in a pull-down menu or other similar menu structure. In one implementation, the minimized windows 208 may be icons instead of tabs, and might be minimized into some miniaturized pictograph representing what that window 206 corresponds to.

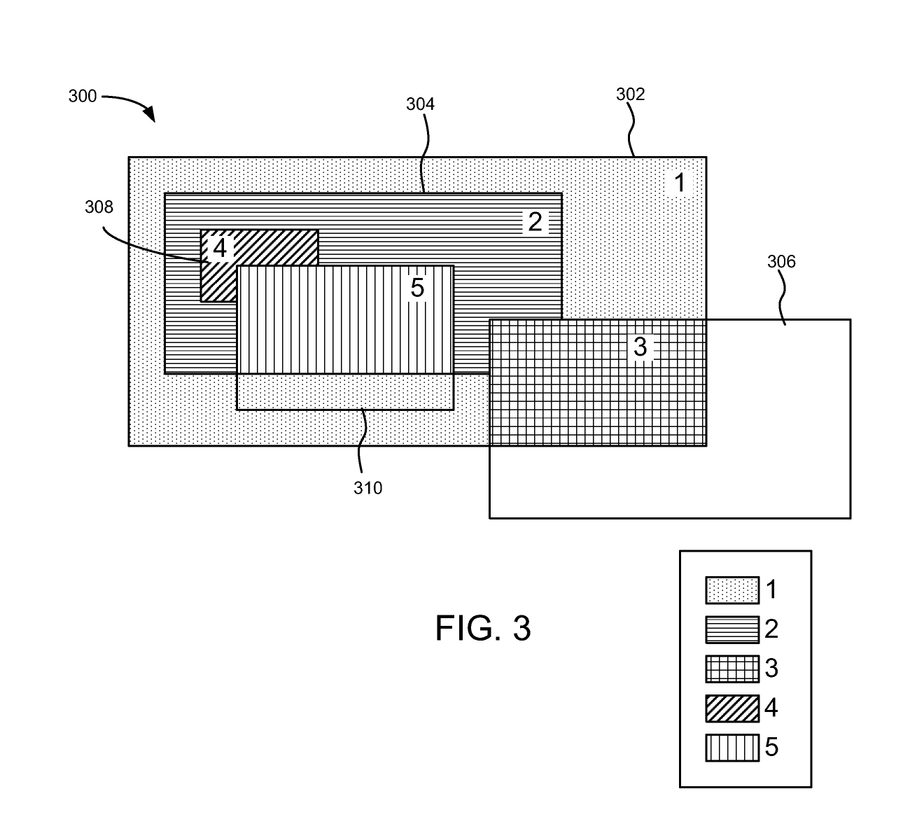

FIG. 3 is an illustration of possible placement of windows in a display, in accordance with an aspect of the present disclosure. Display arrangement 300 includes windows 302, 304, 306, 308 and 310, each represented by cross-hatch patterns 1, 2, 3, 4, and 5, respectively. In one implementation, root window may be window 302, which covers the whole screen and may also be the active window in which clicks and keyboard input is processed. In one implementation, windows 304 and 306 may be top-level windows that may be second in priority to the root window 302, or possibly sub-windows of root window 302 (with the root window 302 being its parent). In other words, if an object or element is clicked or selected in root window 302, it opens up in the top-level windows 304 and 306, for example. In one implementation, windows 308 and 310 may be sub-windows of window 304. In other words, if an object or element is clicked or selected in window 304, it opens up in windows 308 and 310, for example. In one implementation, the parts of a given window that are outside of its parent are not visible. For example, in the case of FIG. 3, the parts of window 310 outside its parent, window 304, may not be visible because window 310 is a sub-window of window 304. Likewise, the parts of window 306 outside its parent, window 302, may not be visible because window 306 is a sub-window of window 302, the root window in this case. FIG. 3 is merely an illustrative placement of windows and layers of windows, and the windows can be positioned in any form or configuration similar to, or not similar to what is shown in FIG. 3.

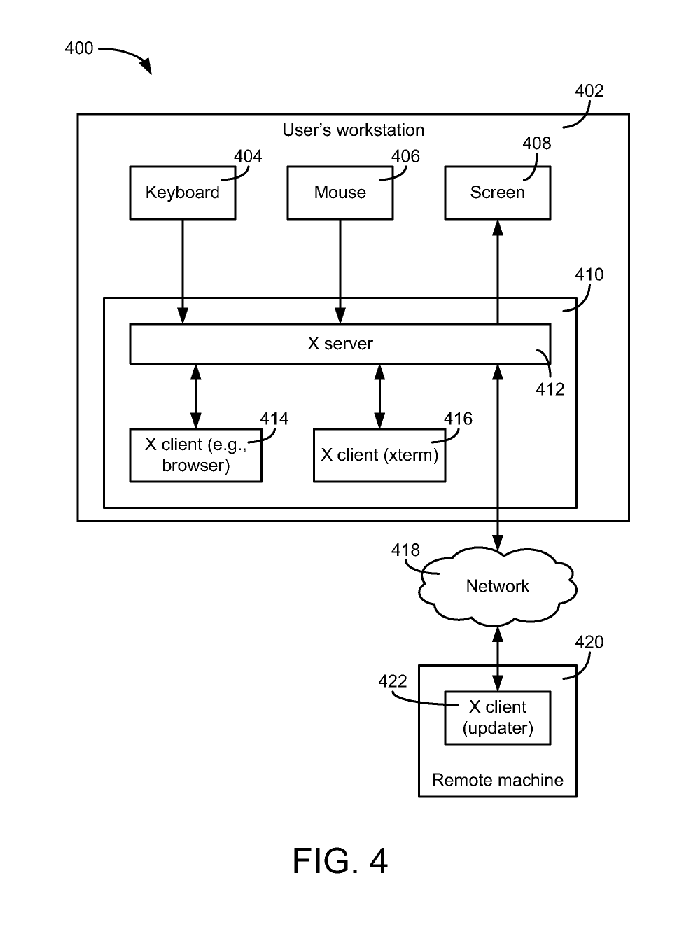

FIG. 4 is a block diagram of a user interface system, in accordance with an aspect of the present disclosure. User interface system 400 includes user's workstation 402, keyboard 404, mouse 406, screen 408, X server system 410, X server 412, X client 414, X client 416, Network 418, remote machine 420 and X client 422. User interface system 400 may be an example of a user interface system that the present disclosure distinguishes from, or it could include components that the present disclosure may use, or may be used to implement the focus detector system according to implementations of the present disclosure. The X server 412 may take input from keyboard 404, mouse 406, or screen 408 (if it is a touch-screen interface, for example) and displays that input into an action on the screen 408. Programs such as web browsers, applications and terminal emulators run on the user's workstation 402 (such as X client 414 representing a browser and X client 416 representing a terminal emulator or xterm program), and a system updater such as X client 422 (implemented as an updater) runs on a remote server on a remote machine 420 but may be under the control of the user's machine or user's workstation 402 via the network 418. In one implementation, the remote application or remote client 422 in remote machine 420 may run just as it would locally.

An X server 412 program within X server system 410 may run on a computer with a graphical display and communicates with a variety of client programs (such as 414, 416). The X server 412 acts as a go-between for the user programs and the client programs, accepting requests for graphical outputs (such as windows) from the client programs and displaying them to the user via screen 408 for instance, and receiving user input (via keyboard 404 or mouse 406) and transmitting that data to the client programs.

In particular, whenever an attempt to show, open or select a new window is made, this request may be redirected to the window manager, which decides the initial position of the window. Additionally, most modern window managers are preparenting programs, which usually leads to a banner being placed at the top of the screen and a decorative frame being drawn around the window. These two elements may be controlled by the window manager rather than the program. Therefore, when the user clicks or drags these elements, it is the window manager that takes the appropriate actions, such as moving or resizing the windows. While one of the primary aims of the window manager is to manage the windows, many window managers have additional features such as handling mouse clicks in the root window (e.g., changing the focus to the root window when it is clicked), presenting panes and other visual elements, handling some keystrokes (such as, for example, Alt-F4 closing a window), deciding which application to run at start-up and so on.

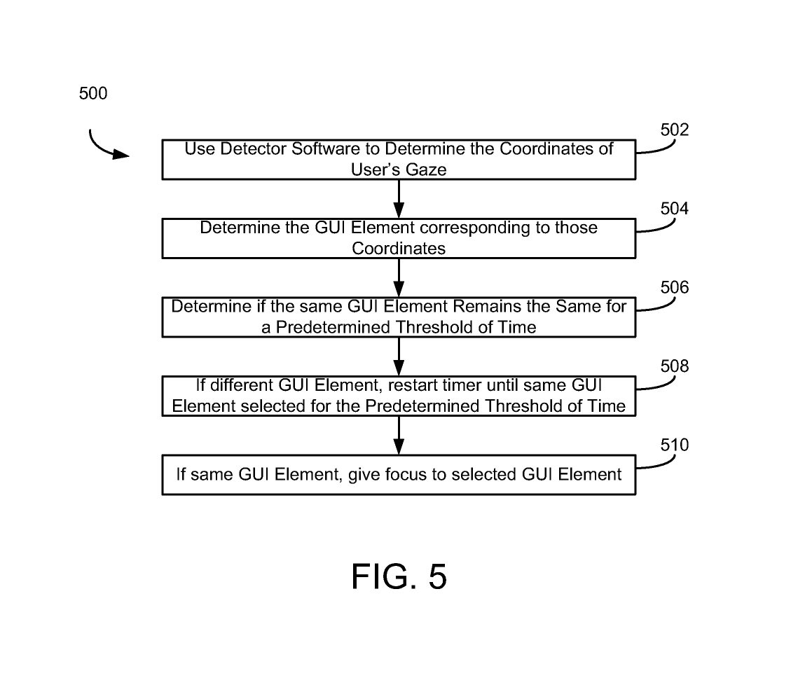

FIG. 5 is an example process for providing window selection based on sensor data such as eye tracking, for example, in accordance with an aspect of the present disclosure. Process 500 may be performed in any order and is not limited to the order shown in FIG. 5. In box 502, detector software is used to determine the coordinates of the user's gaze. In one implementation, this can be off-the-shelf eye-detection software configured for an infrared camera that focuses on eye movement or retina movement, or a simple camera such as a web camera. In one implementation, the may be motion detection software configured for a motion sensor that focuses on nose, mouth, cheek, or other facial movement, or arm, finger movement, or any other movement that would indicate the coordinates of the user's focus or gaze. In one implementation, the coordinates may be represented by an (x, y) coordinate value, or any other value that would represent the location or point of focus of a user's gaze or the user's eyes. In box 504, the GUI element corresponding to the coordinates of the user's gaze is determined. The GUI element can be, for example, an icon, a window, part of a window, a website, a piece of content on a website, an icon on a website, and so on. In one implementation, for a large GUI element such as a large window, any point on that GUI element would count as being part of that GUI element and would return that GUI element. In one implementation, for a large GUI element with parts, the particular point within a certain part would return just that part of the GUI element. In one implementation, for a small GUI element, the specific point of that GUI element would return that GUI element, even if it was located adjacent to another GUI element—in that case, a specific tolerance for detail, perhaps set by a number of pixels, may be utilized.

In box 506, whether the GUI element remains the same or the subject of the user's gaze for a predetermined threshold of time is determined. In one implementation, the predetermined threshold of time might be a couple seconds or longer, or based on psychological or scientific studies on how long a user has to focus on something for their attention to be changed to it, correcting for medical conditions or eye conditions that might take a longer time. In one implementation, if the same GUI element is returned or detected corresponding to the coordinates of the user's gaze for the predetermined threshold of time, a logic high occurs which represents that the GUI element is the one being selected, and box 510 may then be executed. In one implementation, if a different GUI element is returned or detected corresponding to the coordinates of the user's gaze for any time less than the predetermined threshold of time, then a logic low occurs and the clock is started over until the same GUI element is returned or detected for the predetermined threshold of time, which may happen in box 508. In box 508, which may depend on the results of box 506, the clock is restarted if a different GUI element is returned or detected before the predetermined threshold of time. In box 510, which may depend on the results of box 506, the logic high indicating that the same GUI element has been selected, returned or detected for at least the predetermined threshold of time is used to make the system to give or provide focus to the selected GUI element. For instance, if the GUI element was a window behind a certain window, the focus would be granted to that window and all of a sudden that window would come to the foreground of the display screen and be the active window. In one implementation, this selection of the focused object could also be selected via the X window management system as shown in FIG. 4, where the eye/motion detection sensor and software system would act like one of the user devices such as keyboard 404, mouse 406, and screen 408, and would send input to the X server 412 so as to execute that action onto the screen 408, perhaps via clients 414 or 416. In one implementation, the selection of the focused object may utilize a different windows management system that is unlike the X window management system as shown in FIG. 4. In one implementation, the selection of the focused object may use a system that is similar to the X window management system as shown in FIG. 4, or borrows parts of it, or modifies others parts of it while keeping some of the parts the same. The GUI element also becomes available for input, such as, movement, typing into, resizing, minimizing, closing, and so on. In one implementation, focus is given to the selected GUI element in that the selected GUI element is made active and available for input without requiring any additional action from the user. In other words, the user does not need to click or perform any additional action to make that GUI element active and available for input. In one implementation, a sub-GUI element within the actively selected GUI element or window such as a text input box, for example, can be made ready for instant input. In one implementation, after focus is given to the selected GUI element, the user may interact with or select sub-GUI elements within that GUI element with the same process described above, involving the timer and the predetermined threshold of time. For example, the user may decide to click on a button or move a cursor or make a text box active and ready for input within the selected UI element with just his or her gaze. This may be performed by a similar process to the above. For the movement of the object, an object is first selected by the above-described process and then a prompt—in the form of a GUI pop-up or icon—appears confirming that the selected object is the one desired to be moved. Once the user confirms that it is, the user may then move that object using his or her gaze. If the user wishes to select and make active a text box, for example, within the selected GUI element, then the user would look at the text box for a predetermined amount of time and wait until the cursor is active within that text box to then input text. In one implementation, when the user's gaze focuses on an user interface element, the user interface element or the window having the user interface element does not zoom in, nor is the screen size or aspect ratio of the screen or window size adjusted.

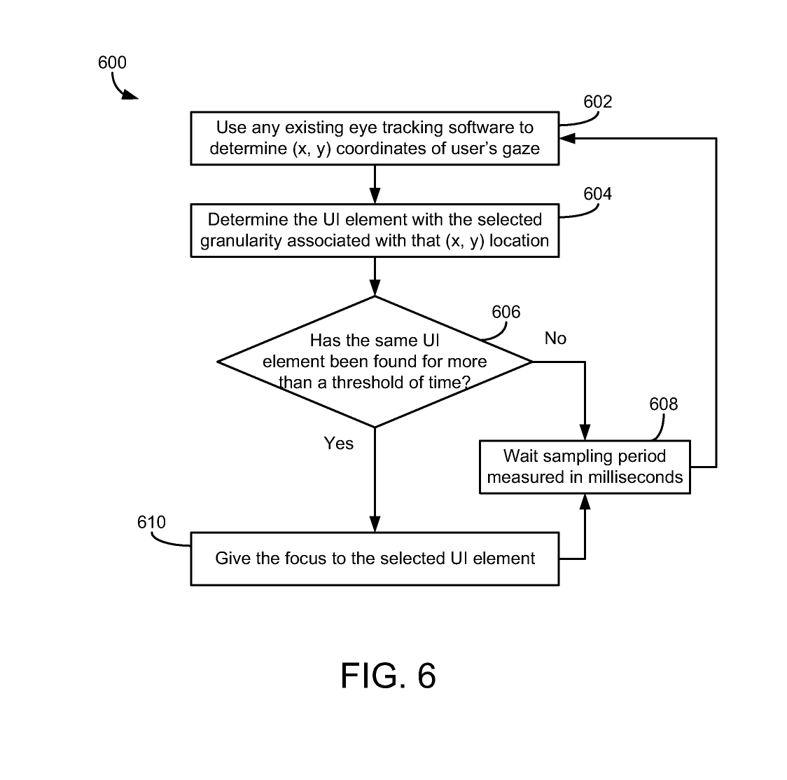

FIG. 6 is another example process for providing window selection based on sensor data such as eye tracking, for example, in accordance with an aspect of the present disclosure. Process 600 may also be performed in any order, and may not necessarily be limited to the order shown in FIG. 6. In box 602, any existing off-the-shelf eye tracking software or motion detecting software is used to determine the coordinates (e.g., (x,y) representation of coordinates) of the user's gaze. In one implementation, the tracking software may be configured for an infrared camera that detects eye movements, or a camera such as a web camera. In one implementation, the tracking software may be configured for a motion sensor that detects facial movements of any part of the face or eye movements or finger movements in order to ascertain the location of the user's gaze or focus. In one implementation, the coordinates may be represented as (x,y) coordinates or as (x,y,z) coordinates, z representing a third dimension, or (x,y,t) coordinates, t representing time, or any set of coordinates that accurately describes the point of the user's gaze or focus.

In box 604, the user interface (UI) element associated with the selected granularity associated with the coordinates of the user's gaze is determined. In one implementation, the granularity may be determined on the order of pixels or some other criteria that represents the location of the coordinates according to some scale or distance. In one implementation, the granularity and tolerance may be adjusted based on how accurate a reading is desired—for instance if one UI element is located a certain number of pixels away from another UI element, the granularity will determine whether those UI elements will be considered different UI elements or the same UI element. Once the UI element corresponding to the coordinates of the user's gaze is determined, it is detected and then returned.

In box 606, a decision occurs of whether or not the same UI element has been detected, returned, found or selected for longer than (or greater than or equal to) a predetermined threshold of time. In one implementation, the predetermined threshold of time may be set to be a few seconds, or longer, in order to take into account medical conditions or eye conditions that would cause the threshold of time to be longer. In one implementation, a clock begins to run as soon as a UI element is selected. The clock can be reset back to zero, for instance when a different UI element is returned. The clock may also be made to reset back to zero if it goes past the predetermined threshold of time.

In box 608, which is the result if the answer is “No” to box 606, the clock waits a sampling period, which may be measured in milliseconds, before returning to box 602 in order to start the process all over again. In one implementation, the sampling period may be the same time period as the predetermined threshold of time. In one implementation, the sampling period may be an additional brief time period after the predetermined threshold of time runs taken in order to reset the clock and reset the detection software and/or devices. In one implementation, the predetermined threshold of time and the sampling period may be measured in milliseconds, microseconds, seconds or any other reasonable period of time that would be appropriate for the detection software to make a decision.

In box 610, which is the result if the answer is “Yes” to box 606, the focus is given to the selected UI element. If the UI element is part of a window or a window, for example, then the “active” window becomes that window. For instance, if the UI element that the user is focusing on is a window located behind another window, that window will all of a sudden come to the foreground. If the UI element is an application, widget or other UI/GUI, then that UI element becomes “active” and the user can then interact with it. The UI element also becomes available for input, such as, movement, typing into, resizing, minimizing, closing, and so on. In one implementation, focus is given to the selected UI element in that the selected UI element is made active and available for input without requiring any additional action from the user. In other words, the user does not need to click or perform any additional action to make that UI element active and available for input. In one implementation, a sub-UI element within the actively selected UI element or window such as a text input box, for example, can be made ready for instant input. In one implementation, after focus is given to the selected UI element, the user may interact with or select sub-UI elements within that UI element with the same process described above, involving the timer and the predetermined threshold of time. For example, the user may decide to click on a button (a sub UI element) or move a cursor within the selected UI element or make a text box active and ready for input within the selected UI element with just his or her gaze. This may be performed by a similar process to the above, especially the selection act. For the movement of the object, an object is first selected by the above-described process and then a prompt—in the form of a GUI pop-up or graphical icon—may appear confirming that the selected object is the one desired to be moved. Once the user confirms that it is, the user may then move that object using his or her gaze, with the movement of the object tracking the movement of the user's gaze. If the user wishes to select and make active a text box, for example, within the selected GUI element, then the user would look at the text box for a predetermined amount of time and wait until the cursor is active within that text box to then input text In another example, the system may be configured to recognize the user's gaze at a window and, in response, the system may do one or more of: display the window on top of other open windows, select a default user input field within the window, and make a cursor active within the user input field in preparation for a user to enter text into the user input field. When a selected window has multiple user input fields, the system may store a last active input field from the last time the user interacted with that window as the default user input field. In other examples, the default user input field may be a first user input field (e.g., top, left) on a page being displayed by the window, a first user input field (again, e.g., top, left) in a currently viewed area of a page, or a randomly-selected user input field, etc. In one implementation, when the user's gaze focuses on an user interface element, the user interface element or the window having the user interface element does not zoom in, nor is the screen size or aspect ratio of the screen or window size adjusted.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied in a tangible medium, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus or processing circuit on data stored on one or more computer-readable storage devices or received from other sources.

The term “client” or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors or processing circuits executing one or more computer programs to perform actions by operating on input data and generating output. The processes and logic flows can also be performed by, and apparatus can also be implemented as, special purpose logic circuitry, e.g., an FPGA or an ASIC.

Processors or processing circuits suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface (GUI) or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

While the above description contains many specifics, these specifics should not be construed as limitations on the scope of the invention, but merely as exemplifications of the disclosed implementations. Those skilled in the art will envision many other possible variations that are within the scope of the invention as defined by the claims appended hereto.

What is claimed is:

1. A computerized method, comprising:
determining, via a computing device, a set of coordinates corresponding to a user's gaze;
determining, via the computing device, a user interface (UI) element corresponding to the set of coordinates;
returning, via the computing device, that UI element as being detected and again repeating the determination of the set of coordinates corresponding to the user's gaze;
determining, via the computing device, if the UI element being returned is the same for a predetermined threshold of time according to a started timer;
if the UI element is not the same, resetting, via the computing device, the started timer and again repeating the determination of the set of coordinates corresponding to the user's gaze; and
if the UI element is the same, making the UI element active, via the computing device, without requiring any additional action from the user and currently selecting the UI element to receive input.

2. The method of claim 1, wherein determining, via the computing device, the set of coordinates corresponding to the user's gaze comprises:
using a tracking device configured with a sensor that detects the location of where the user's gaze is focusing at, the sensor comprising at least one of a camera that focuses on eye motion, an infrared camera, a motion sensor and an infrared motion sensor; and
returning the set of coordinates that corresponds to the detected location; and
receiving an adjustable tolerance value to modify the accuracy of the detected location

3. The method of claim 1, wherein determining, via the computing device, the UI element corresponding to the set of coordinates comprises:
looking up which UI element the set of coordinates touches; and
returning the UI element, wherein looking up which UI element the set of coordinates touches comprises looking up which UI element the set of coordinates belongs to, and further wherein the accuracy of the touching of the set of coordinates may be modified via an adjustable granularity.

4. The method of claim 1, wherein returning, via the computing device, that UI element as being detected and again repeating the determination of the set of coordinates corresponding to the user's gaze comprises:
storing the detected UI element;
returning to the determination, via the computing device, of an other set of coordinates corresponding to the user's gaze; and
determining, via the computing device, an other UI element corresponding to the other set of coordinates.

5. The method of claim 4, wherein determining, via the computing device, if the UI element being returned is the same for the predetermined threshold of time according to the started timer comprises:
starting the started timer from zero;
determining if the other UI element matches the stored detected UI element; and
if there is a match between the other UI element and the stored detected UI element, continuing to increment the started timer.

6. The method of claim 5, wherein if the UI element is not the same, resetting, via the computing device, the started timer and again repeating the determination of the set of coordinates corresponding to the user's gaze comprises:
if there is not a match between the other UI element and the stored detected UI element, resetting the started timer to zero;
returning to the determination, via the computing device, of a new other set of coordinates corresponding to the user's gaze to replace the other set of coordinates; and
determining, via the computing device, a new other UI element corresponding to the other set of coordinates to replace the other UI element.

7. The method of claim 6, further comprising:
storing the other UI element as the detected UI element;
starting the started timer from zero;
determining if the new other UI element matches the stored detected UI element; and
if there is a match between the new other UI element and the stored detected UI element, continuing to increment the started timer.

8. The method of claim 1, wherein if the UI element is the same, making the UI element active, via the computing device, and currently selecting the UI element to receive input comprises:
making the UI element active by allowing the user to interact with it; and
storing the UI element as the active UI element.

9. The method of claim 8, wherein if the UI element is the same, making the UI element active, via the computing device, and currently selecting the UI element to receive input comprises:
if the UI element is the same as the previously stored UI element, then making no change between the active UI element at all.

10. The method of claim 1, wherein an UI element is made active in that the user can interact with the active UI element and further wherein there can only be one active UI element at a time.

11. The method of claim 1, further comprising:
selecting, via the computing device, a sub UI element within the selected active UI element in the same way the active UI element is selected; and
interacting, via the computing device, with the selected sub UI element within the selected active UI element.

12. The method of claim 1, further comprising:
determining, via the computing device, a set of coordinates corresponding to the user's gaze;
determining, via the computing device, a sub UI element within the selected active UI element corresponding to the set of coordinates;
returning, via the computing device, that sub UI element as being detected and again repeating the determination of the set of coordinates corresponding to the user's gaze;
determining, via the computing device, if the sub UI element being returned is the same for a predetermined sub threshold of time according to a started sub timer;
if the sub UI element is not the same, resetting, via the computing device, the started sub timer and again repeating the determination of the set of coordinates corresponding to the user's gaze;
if the sub UI element is the same, making the sub UI element active, via the computing device, and currently selecting the sub UI element to receive input; and
allowing the user to perform an action on the sub UI element, the action being able to be performed by using the user's gaze.

13. A tangible computer-readable storage medium having instructions thereon that cause one or more processors to perform operations, the operations comprising:
determining a set of coordinates corresponding to a user's gaze;
determining an user interface (UI) element corresponding to the set of coordinates;
returning that UI element as being detected and again repeating the determination of the set of coordinates corresponding to the user's gaze;
determining if the UI element being returned is the same for a predetermined threshold of time according to a started timer;
if the UI element is not the same, resetting the started timer and again repeating the determination of the set of coordinates corresponding to the user's gaze; and
if the UI element is the same, giving focus to the UI element and making the UI element active without requiring any additional action from the user.

14. The computer-readable storage medium of claim 13, wherein determining the set of coordinates corresponding to the user's gaze comprises:
using tracking software configured with a sensor that detects the location of where the user's gaze is focusing at, the sensor comprising a camera that focuses on eye motion, an infrared camera, a motion sensor and an infrared motion sensor; and
returning the set of coordinates that corresponds to the detected location, wherein the accuracy of the detected location can be modified via an adjustable tolerance.

15. The computer-readable storage medium of claim 13, wherein determining the UI element corresponding to the set of coordinates comprises:
looking up which UI element the set of coordinates touches; and
returning the UI element, wherein looking up which UI element the set of coordinates touches comprises looking up which UI element the set of coordinates belongs to, and further wherein the accuracy of the touching of the set of coordinates may be modified via an adjustable granularity.

16. The computer-readable storage medium of claim 13, wherein returning that UI element as being detected and again repeating the determination of the set of coordinates corresponding to the user's gaze comprises:
storing the detected UI element;
returning to the determination of an other set of coordinates corresponding to the user's gaze; and
determining an other UI element corresponding to the other set of coordinates.

17. The computer-readable storage medium of claim 16, wherein determining if the UI element being returned is the same for the predetermined threshold of time according to the started timer comprises:
starting the started timer from zero;
determining if the other UI element matches the stored detected UI element; and
if there is a match between the other UI element and the stored detected UI element, continuing to increment the started timer.

18. The computer-readable storage medium of claim 17, wherein if the UI element is not the same, resetting, via the computing device, the started timer and again repeating the determination of the set of coordinates corresponding to the user's gaze comprises:
if there is not a match between the other UI element and the stored detected UI element, resetting the started timer to zero;
returning to the determination of a new other set of coordinates corresponding to the user's gaze to replace the other set of coordinates; and
determining a new other UI element corresponding to the other set of coordinates to replace the other UI element.

19. The computer-readable storage medium of claim 18, further comprising:
storing the other UI element as the detected UI element;
starting the started timer from zero;
determining if the new other UI element matches the stored detected UI element; and
if there is a match between the new other UI element and the stored detected UI element, continuing to increment the started timer.

20. The computer-readable storage medium of claim 13 wherein if the UI element is the same, giving focus to the UI element comprises:
making the UI element active by allowing the user to interact with it; and
storing the UI element as the active UI element.

21. The computer-readable storage medium of claim 20, wherein if the UI element is the same, giving focus to the UI element comprises:
if the UI element is the same as the previously stored UI element, then making no change between the active UI element at all.

22. The computer-readable storage medium of claim 13, further comprising:
selecting a sub UI element within the selected active UI element in the same way the active UI element is selected; and
interacting with the selected sub UI element within the selected active UI element.

23. The computer-readable storage medium of claim 13, further comprising:
determining a set of coordinates corresponding to the user's gaze;
determining a sub UI element within the selected active UI element corresponding to the set of coordinates;
returning that sub UI element as being detected and again repeating the determination of the set of coordinates corresponding to the user's gaze;
determining if the sub UI element being returned is the same for a predetermined sub threshold of time according to a started sub-timer;
if the sub UI element is not the same, resetting the started sub-timer and again repeating the determination of the set of coordinates corresponding to the user's gaze;
if the sub UI element is the same, making the sub UI element active and currently selecting the sub UI element to receive input; and
allowing the user to perform an action on the sub UI element, the action being able to be performed by using the user's gaze.

24. A system comprising:
a display device comprising a screen having a plurality of user interface elements, wherein only one of the plurality of user interface elements can be active at a time;
at least one user device allowing a user to directly interact with the plurality of user interface elements; and
at least one sensor configured with software that detects the user interface element that the user's gaze is focused on and makes that detected user interface element the active one.
